(19) United States
(12) Patent Application Publication
(10) Pub. No.: US 2025/0183286 A1
(43) Pub. Date: Jun. 5, 2025

(54) METHOD FOR COATING CATHODE ACTIVE MATERIAL WITH ALKALI-DOPED ALUMINA USING SPRAY DRYING

(71) Applicant: GM GLOBAL TECHNOLOGY OPERATIONS LLC, Detroit, MI (US)

(72) Inventors: Vamakshi YADAV, Sterling Height, MI (US); Yuntao GU, Farmington Hills, MI (US); Raneen TAHA, Sterling Heights, MI (US); Zhongyi LIU, Troy, MI (US)

(21) Appl. No.: 18/525,968

(22) Filed: Dec. 1, 2023

(51) Int. Cl. H01M 4/505; H01M 4/02; H01M 4/04; H01M 10/052

(52) U.S. Cl. CPC H01M 4/505; H01M 4/0419; H01M 4/0471; H01M 10/052; H01M 2004/028

(57) ABSTRACT

A method for manufacturing a battery cell includes adding powder including cathode active material to an aqueous solution including a coating precursor. The aqueous solution and heated gas is spray dried through an atomization nozzle to produce coated particles. The coated particles of the cathode active material are calcined at a predetermined temperature for a predetermined period.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to a method for coating cathode active material with alkali-doped alumina using spray drying.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

Battery cells include cathode electrodes, anode electrodes, and separators. The cathode electrodes include a cathode active material layer (including cathode active material) arranged on a cathode current collector. The anode electrodes include an anode active material layer (including anode active material) arranged on an anode current collector.

### SUMMARY

A method for manufacturing a battery cell includes adding powder including cathode active material to an aqueous solution including a coating precursor; spraying drying the aqueous solution and heated gas through an atomization nozzle to produce coated particles; and calcining the coated particles of the cathode active material at a predetermined temperature for a predetermined period.

In other features, the coating precursor comprises an alkali-doped alumina coating. The coating precursor is selected from a group consisting of sodium aluminate, sodium aluminum silicate, sodium silicate, sodium zirconate, sodium niobate, cerium aluminate, sodium titanate, sodium bismuth titanate, sodium phosphate, sodium molybdate, sodium tungstate, sodium borate, sodium dichromate, and combinations thereof.

In other features, the cathode active material is selected from a group consisting of lithium- and manganese-rich (LMR), lithium nickel manganese cobalt oxide (NMC), nickel cobalt manganese aluminum (NCMA), lithium iron phosphate (LFP), lithium nickel oxide (LNO), lithium manganese iron phosphate (LMFP), lithium manganese oxide (LMO), and combinations thereof.

In other features, the method includes manufacturing C cathode electrodes including the coated particles of the cathode active material; arranging the C cathode electrodes, A anode electrodes, and S separators in a battery cell stack of the battery cell; and selectively operating the battery cell in a voltage range including an upper limit exceeding 4.2V.

In other features, the predetermined temperature is in a range from 400° C. to 500° C. The predetermined temperature is 450° C. and the predetermined period is 120 minutes. The predetermined period is in a range from 60 minutes to 180 minutes. A concentration of the cathode active material in the aqueous solution is in a range from 0.5 g/30 ml to 1.5 g/30 ml. The atomization nozzle is pulsed at a frequency in a range from 0.1 Hz to 0.3 Hz. A flow rate of the heated gas is in a range from 20 L/min to 40 L/min. The heated gas has a temperature in a range from 100° C. to 180° C.

A battery cell includes A anode electrodes, C cathode electrodes including lithium- and manganese-rich (LMR) cathode active material with an alkali-doped alumina coating, and S separators, where C, A, and S are integers greater than one. In other features, the alkali-doped alumina coating is applied using spray drying.

In other features, a coating precursor forming the alkali-doped alumina coating is selected from a group consisting of sodium aluminate, sodium aluminum silicate, sodium silicate, sodium zirconate, sodium niobate, cerium aluminate, sodium titanate, sodium bismuth titanate, sodium phosphate, sodium molybdate, sodium tungstate, sodium borate, sodium dichromate, and combinations thereof. The cathode active material is selected from a group consisting of lithium- and manganese-rich (LMR), lithium nickel manganese cobalt oxide (NMC), nickel cobalt manganese aluminum (NCMA), lithium iron phosphate (LFP), lithium nickel oxide (LNO), lithium manganese iron phosphate (LMFP), lithium manganese oxide (LMO), and combinations thereof.

In other features, the method includes selectively operating the battery cell in a voltage range including an upper limit exceeding 4.3V.

A method for coating cathode active material for a cathode electrode of a battery cell includes adding powder including cathode active material to an aqueous solution including a coating precursor. The cathode active material is selected from a group consisting of lithium- and manganese-rich (LMR), lithium nickel manganese cobalt oxide (NMC), nickel cobalt manganese aluminum (NCMA), lithium iron phosphate (LFP), lithium nickel oxide (LNO), lithium manganese iron phosphate (LMFP), lithium manganese oxide (LMO), and combinations thereof. The coating precursor is selected from a group consisting of sodium aluminate, sodium aluminum silicate, sodium silicate, sodium zirconate, sodium niobate, cerium aluminate, sodium titanate, sodium bismuth titanate, sodium phosphate, sodium molybdate, sodium tungstate, sodium borate, sodium dichromate, and combinations thereof. The method includes spraying drying the aqueous solution and heated gas through an atomization nozzle to produce coated particles. The method includes calcining the coated particles of the cathode active material at a predetermined temperature for a predetermined period.

In other features, the method includes manufacturing C cathode electrodes including the coated particles of the cathode active material; arranging the C cathode electrodes, A anode electrodes, and S separators in a battery cell stack of the battery cell; and selectively operating the battery cell in a voltage range including an upper limit exceeding 4.2V.

In other features, the predetermined temperature is in a range from 400° C. to 500° C., and the predetermined period is in a range from 60 minutes to 180 minutes.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross sectional view of an example of a battery cell including cathode electrodes with cathode active material that is coated with alkali-doped alumina, anode electrodes, and separators according to the present disclosure;

FIG. 2 is a side cross sectional view of an example of a cathode electrode with cathode active material that is coated with alkali-doped alumina according to the present disclosure;

FIGS. 3A and 3B are enlarged views of an example of the cathode active material that is coated with alkali-doped alumina according to the present disclosure;

FIG. 4 is a flowchart of an example of a method for coating the cathode active material with alkali-doped alumina according to the present disclosure;

FIG. 5 is a graph illustrating an example of discharge capacity and discharge capacity retention percentage for coated and uncoated cathode active material including LMR according to the present disclosure;

FIGS. 6A to 6C are scanning electron microscope images of an example of uncoated cathode active material and coated cathode active material at different concentrations of aluminum according to the present disclosure; and

FIG. 6D is a scanning electron microscope image of an example of LMR cathode active material coated with metal oxide using ALD.

In the drawings, reference numbers may be reused to identify similar and/or identical elements.

### DETAILED DESCRIPTION

While battery cells according to the present disclosure are shown in the context of electric vehicles, the battery cells can be used in stationary applications and/or other applications.

Conventional metal oxide-based coatings improve cycle life of cathode active materials in lithium-ion batteries. Although vapor deposition techniques such as atomic layer deposition (ALD) and chemical vapor deposition (CVD) can be used to precisely coat the cathode active material powder to a desired coating thickness, ALD and CVD methods are expensive and use hazardous chemicals.

The present disclosure relates to a spray drying, water-based coating method for coating cathode active material particles using an alkali-doped alumina coating. The cathode active material is selected from a group consisting of lithium- and manganese-rich (LMR), lithium nickel manganese cobalt oxide (NMC), nickel cobalt manganese aluminum (NCMA), lithium iron phosphate (LFP), lithium nickel oxide (LNO), lithium manganese iron phosphate (LMFP), lithium manganese oxide (LMO), and combinations thereof. The cathode active material is coated with alkali-doped alumina.

In some examples, the coating precursor for the alkali-doped alumina coating is selected from a group consisting of sodium aluminate, sodium aluminum silicate, sodium silicate, sodium zirconate, sodium niobate, cerium aluminate, sodium titanate, sodium bismuth titanate, sodium phosphate, sodium molybdate, sodium tungstate, sodium borate, sodium dichromate, and combinations thereof. While the foregoing examples of coating precursors for sodium are described, in other examples the coating precursor includes other alkali metals such as lithium, sodium or potassium also be used.

The spray drying, water-based coating method is a low-cost, high throughput and benign manufacturing process for depositing a coating precursor (e.g., sodium aluminate (NaAlO₂)) on a surface of particles of the cathode active material (e.g., lithium- and manganese-rich (LMR) cathode active material). For example only, when using sodium aluminate, it is believed that a sodium counterion in the molecular complex creates defects in the deposited sodium (Na)-doped alumina layer that ensure good ionic conductivity. As reactive sites are masked by the NaAlO₂ coating, unwanted reactions between cathode and electrolyte subside. As a result, the coated LMR particles exhibit significant enhancement in capacity retention.

Referring now to FIG. 1, a battery cell 10 includes C cathode electrodes 20, A anode electrodes 40, and S separators 32 arranged in a predetermined sequence in a battery cell stack 12, where C, S and A are integers greater than zero. The battery cell stack 12 is arranged in an enclosure 50. Liquid electrolyte 52 is added to the enclosure 50. The C cathode electrodes 20-1, 20-2, . . . , and 20-C include a cathode active material layer 24 on one or both sides of a cathode current collector 26. The A anode electrodes 40-1, 40-2, . . . , and 40-A include anode active material layers 42 arranged on one or both sides of the anode current collectors 46.

During charging/discharging, the A anode electrodes 40 and the C cathode electrodes 20 exchange lithium ions. In some examples, the cathode active material layers 24 and/or the anode active material layers 42 comprise coatings including one or more active materials, one or more conductive additives, and/or one or more binder materials that are applied to the current collectors.

In some examples, the cathode current collector 26 and/or the anode current collector 46 comprise metal foil, metal mesh, perforated metal, 3 dimensional (3D) metal foam, and/or expanded metal. In some examples, the current collectors are made of one or more materials selected from a group consisting of copper, stainless steel, brass, bronze, zinc, aluminum, and/or alloys thereof. External tabs 28 and 48 are connected to the current collectors of the cathode electrodes and anode electrodes, respectively, and can be arranged on the same or different sides of the battery cell stack 12. The external tabs 28 and 48 are connected to terminals of the battery cells.

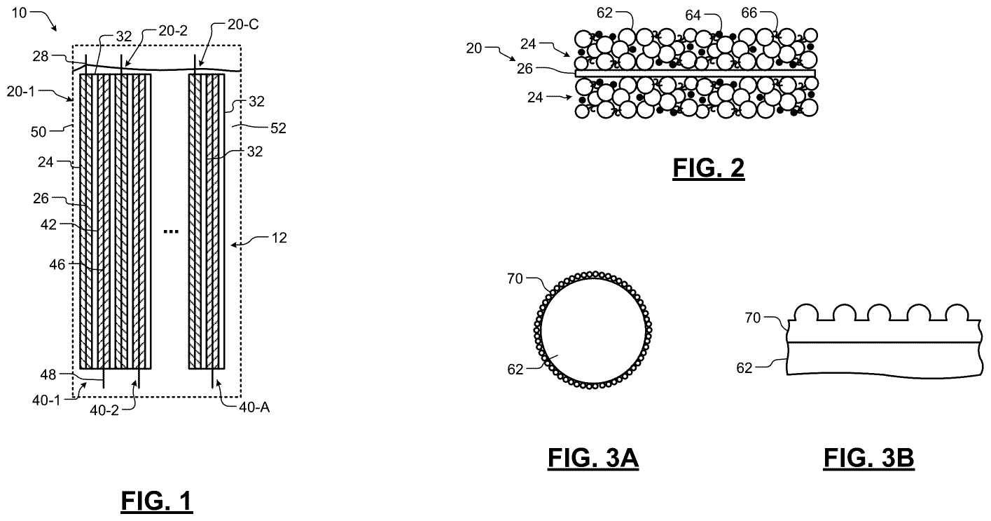

Referring now to FIG. 2, one of the C cathode electrodes 20 is shown in more detail. The cathode active material layer 24 of the one of the C cathode electrodes 20 includes a cathode active material 62, an optional conductive additive 64, and an optional binder 66. In some examples, the cathode active material 62 is coated with alkali-doped alumina. The cathode active material 62 is selected from a group consisting of lithium- and manganese-rich (LMR), lithium nickel manganese cobalt oxide (NMC), nickel cobalt manganese aluminum (NCMA), lithium iron phosphate (LFP), lithium nickel oxide (LNO), lithium manganese iron phosphate (LMFP), lithium manganese oxide (LMO), and combinations thereof.

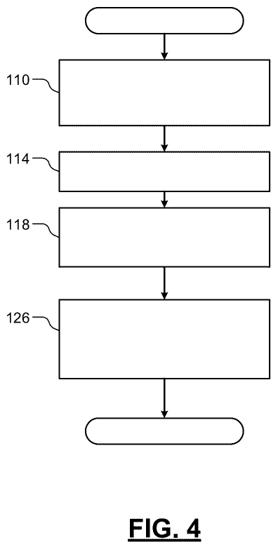

Referring now to FIGS. 3A and 3B, the cathode active material 62 is coated with an alkali-doped alumina coating 70. In some examples, the coating precursor is selected from a group consisting of sodium aluminate, sodium aluminum silicate, sodium silicate, sodium zirconate, sodium niobate, cerium aluminate, sodium titanate, sodium bismuth titanate, sodium phosphate, sodium molybdate, sodium tungstate, sodium borate, sodium dichromate, and combinations thereof. The counter ion in the coating precursors can be any alkali metal (e.g., lithium, sodium, potassium). In some examples, the alkali-doped alumina coating 70 includes a transition metal having a weight concentration in a range from 0.01 wt % to 2 wt %.

Referring now to FIG. 4, a method for coating the cathode active material particles is shown. At 110, the cathode active material powder is added to an aqueous solution of the coating precursor. At 114, the mixture is stirred continuously. At 118, the mixture is sprayed through an atomization nozzle along with heated gas such as air to dry/form the coated cathode active material particles. At 126, the coated active material particles are collected and calcined at a predetermined temperature for a predetermined period. In some examples, the predetermined temperature is in a range from 200° C. to 700° C. (e.g., 450° C.). In some examples, the predetermined period is in a range from 60 minutes to 180 minutes (e.g., 120 minutes).

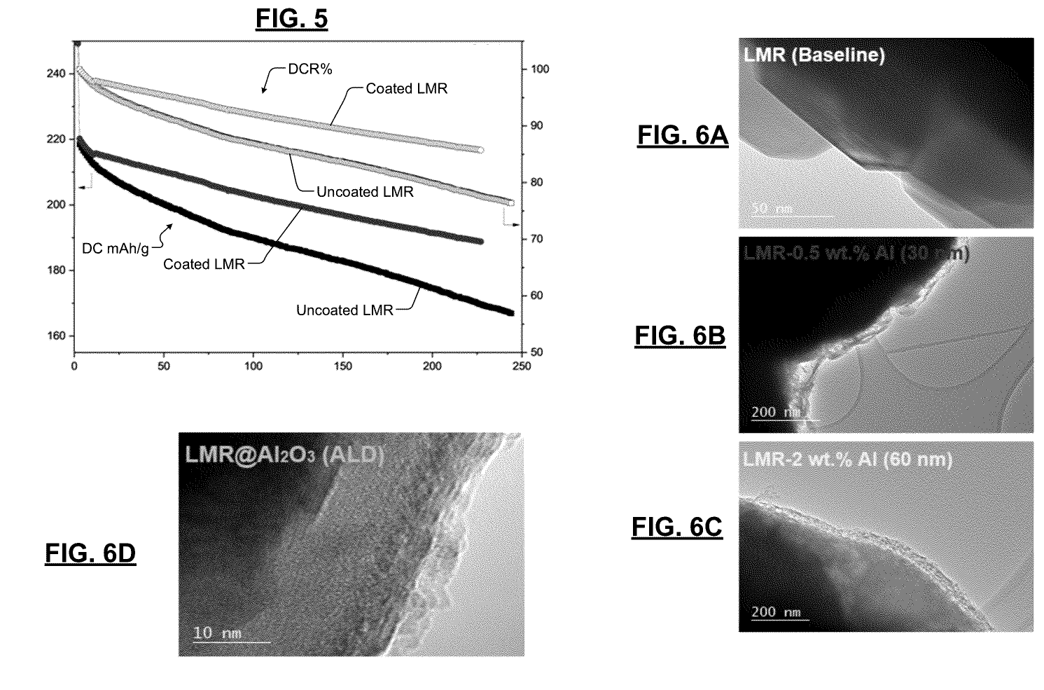

Referring now to FIG. 5, discharge capacity and discharge capacity retention percentage are shown for coated and uncoated LMR cathode active material. In this example, the cathode active material layer includes a mixture of coated or uncoated LMR, a conductive additive, and a binder with a ratio of 94/3/3 wt %. The operating voltage range of the battery cell is from 2V to 5V at a C/3 charge rate. In some examples, the battery cell operates in a voltage range including an upper limit exceeding 4.2V. In some examples, the conductive additive includes carbon black and the binder includes polyvinylidene difluoride (PVDF), although other conductive additives and/or binders can be used. The anode electrode includes 5.5% SiOₓ/graphite as the anode active material. The electrode loading is ˜5 mAh/cm² for positive capacity and 5.5 mAh/cm² for negative capacity. Active mass loading on the cathode electrode is in a range from 24 mg/cm² to 25 mg/cm² and a diameter of the cathode electrode is 12.7 mm.

Referring now to FIGS. 6A to 6D, scanning electron microscope images of examples of uncoated cathode active material and coated cathode active material are shown. In FIG. 6A, an uncoated particle of the LMR cathode active material is shown. In FIGS. 6B and 6C, alkali-doped alumina coated particles of the LMR cathode active material is shown (e.g., with 0.5 wt % Al and 2 wt % Al, respectively). In FIG. 6D, an ALD coated LMR particle is shown. As can be seen by the images, the ALD coating (e.g., a metal oxide) has different properties (and constituents since ALD is not typically used to deposit two metals) as compared to LMR cathode active material coated with alkali-doped alumina.

In some examples, the concentration of the cathode active material powder in the solution is in a range from 0.5 g/30 ml to 1.5 g/30 ml (e.g., 1 g/30 mL). In some examples, the nozzle is pulsed on and off at a frequency in a range from 0.1 Hz to 0.3 Hz (e.g., 0.2 Hz) to ensure that the nozzle is cleaned. In some examples, the drying gas (e.g., air) flow rate is in a range from 20 L/min to 40 L/min (e.g., 30 L/min). In some examples, the drying gas temperature is in a range from 100° C. to 180° C. (e.g., 140° C.). In some examples, a flow rate of mixture to the nozzle is in a range from 3 cc/min to 7 cc/min (e.g., 5 cc/min).

As can be appreciated, molecular precursors such as sodium aluminate allow formation of a compact coating morphology that enhances cycling stability without comprising capacity. Sodium doping in the alumina coating layer creates defects that dictate the coating morphology, porosity, and/or ability to facilitate Li-ion transfer. The coating thickness is tunable by varying the concentration of metal precursor in solution that is spray dried. The method is a low-cost, water-based spray drying coating method that can be easily scaled.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A method for manufacturing a battery cell, comprising:
adding powder including cathode active material to an aqueous solution including a coating precursor;
spraying drying the aqueous solution and heated gas through an atomization nozzle to produce coated particles; and
calcining the coated particles of the cathode active material at a predetermined temperature for a predetermined period.

2. The method of claim 1, wherein the coating precursor comprises an alkali-doped alumina coating.

3. The method of claim 1, wherein the coating precursor is selected from a group consisting of sodium aluminate, sodium aluminum silicate, sodium silicate, sodium zirconate, sodium niobate, cerium aluminate, sodium titanate, sodium bismuth titanate, sodium phosphate, sodium molybdate, sodium tungstate, sodium borate, sodium dichromate, and combinations thereof.

4. The method of claim 1, wherein the cathode active material is selected from a group consisting of lithium- and manganese-rich (LMR), lithium nickel manganese cobalt oxide (NMC), nickel cobalt manganese aluminum (NCMA), lithium iron phosphate (LFP), lithium nickel oxide (LNO), lithium manganese iron phosphate (LMFP), lithium manganese oxide (LMO), and combinations thereof.

5. The method of claim 1, further comprising:
manufacturing C cathode electrodes including the coated particles of the cathode active material;
arranging the C cathode electrodes, A anode electrodes, and S separators in a battery cell stack of the battery cell; and
selectively operating the battery cell in a voltage range including an upper limit exceeding 4.2V.

6. The method of claim 1, wherein the predetermined temperature is in a range from 400° C. to 500° C.

7. The method of claim 1, wherein the predetermined temperature is 450° C. and the predetermined period is 120 minutes.

8. The method of claim 1, wherein the predetermined period is in a range from 60 minutes to 180 minutes.

9. The method of claim 1, wherein a concentration of the cathode active material in the aqueous solution is in a range from 0.5 g/30 ml to 1.5 g/30 ml.

10. The method of claim 1, wherein the atomization nozzle is pulsed at a frequency in a range from 0.1 Hz to 0.3 Hz.

11. The method of claim 1, wherein a flow rate of the heated gas is in a range from 20 L/min to 40 L/min.

12. The method of claim 1, wherein, the heated gas has a temperature in a range from 100° C. to 180° C.

13. A battery cell comprising:
A anode electrodes;
C cathode electrodes including lithium- and manganese-rich (LMR) cathode active material with an alkali-doped alumina coating; and
S separators, where C, A, and S are integers greater than one.

14. The battery cell of claim 13, wherein the alkali-doped alumina coating is applied using spray drying.

15. The battery cell of claim 14, wherein a coating precursor forming the alkali-doped alumina coating is selected from a group consisting of sodium aluminate, sodium aluminum silicate, sodium silicate, sodium zirconate, sodium niobate, cerium aluminate, sodium titanate, sodium bismuth titanate, sodium phosphate, sodium molybdate, sodium tungstate, sodium borate, sodium dichromate, and combinations thereof.

16. The battery cell of claim 13, wherein the cathode active material is selected from a group consisting of lithium- and manganese-rich (LMR), lithium nickel manganese cobalt oxide (NMC), nickel cobalt manganese aluminum (NCMA), lithium iron phosphate (LFP), lithium nickel oxide (LNO), lithium manganese iron phosphate (LMFP), lithium manganese oxide (LMO), and combinations thereof.

17. The battery cell of claim 13, further comprising selectively operating the battery cell in a voltage range including an upper limit exceeding 4.3V.

18. A method for coating cathode active material for a cathode electrode of a battery cell, comprising:
adding powder including cathode active material to an aqueous solution including a coating precursor,
wherein the cathode active material is selected from a group consisting of lithium- and manganese-rich (LMR), lithium nickel manganese cobalt oxide (NMC), nickel cobalt manganese aluminum (NCMA), lithium iron phosphate (LFP), lithium nickel oxide (LNO), lithium manganese iron phosphate (LMFP), lithium manganese oxide (LMO), and combinations thereof, and
wherein the coating precursor is selected from a group consisting of sodium aluminate, sodium aluminum silicate, sodium silicate, sodium zirconate, sodium niobate, cerium aluminate, sodium titanate, sodium bismuth titanate, sodium phosphate, sodium molybdate, sodium tungstate, sodium borate, sodium dichromate, and combinations thereof;
spraying drying the aqueous solution and heated gas through an atomization nozzle to produce coated particles; and
calcining the coated particles of the cathode active material at a predetermined temperature for a predetermined period.

19. The method of claim 18, further comprising:
manufacturing C cathode electrodes including the coated particles of the cathode active material;
arranging the C cathode electrodes, A anode electrodes, and S separators in a battery cell stack of the battery cell; and
selectively operating the battery cell in a voltage range including an upper limit exceeding 4.2V.

20. The method of claim 18, wherein:
the predetermined temperature is in a range from 400° C. to 500° C., and the predetermined period is in a range from 60 minutes to 180 minutes.
